(19) United States
(12) Patent Application Publication
(10) Pub. No.: US 2016/0110816 A1
(43) Pub. Date: Apr. 21, 2016

(54) SYSTEM FOR LOSS CONTROL INSPECTION UTILIZING WEARABLE DATA GATHERING DEVICE

(71) Applicant: Hartford Fire Insurance Company, Hartford, CT (US)

(72) Inventors: Mary B. Cardin, Ellington, CT (US); Philip Peter Hennig, Simsbury, CT (US); Jacob P. Makler, New York, NY (US); Tiffany L. Ryan, Naugatuck, CT (US); Larry S. Sherman, Greenfield, MA (US); Robert J. Sullivan, Simsbury, CT (US)

(21) Appl. No.: 14/518,442

(22) Filed: Oct. 20, 2014

(51) Int. Cl. G06Q 40/08; G10L 15/26; H04N 5/44; G06T 19/00; G02B 27/01

(52) U.S. Cl. CPC G06Q 40/08; G06T 19/006; G02B 27/0172; H04N 5/44; G10L 15/26; G02B 2027/0178

(57) ABSTRACT

Loss control inspections by an insurance company are facilitated by a system that includes a wearable data-gathering device worn by a loss control inspector while he/she conducts an inspection. Other aspects of the system may include a centralized report processor operated by the insurance company, and a mobile device (such as a smartphone) carried by the loss control inspector to relay data between the wearable data-gathering device and the centralized report processor. The loss control inspector may gather verbal and visual information via the wearable data-gathering device, guided by prompts originating from the centralized report processor. The prompts may cause the data to be gathered as required to complete sections of an inspection report format. The centralized report processor may automatically edit and assemble the data gathered via the wearable device to generate a completed inspection report.

### FIELD

The present invention relates to automated generation of insurance loss control inspection reports.

### BACKGROUND

With respect to many property and casualty insurance policies, an important part of the underwriting process includes an on-site inspection for the purpose of assessing, identifying and mitigating the risk of loss at the premises that are to be insured. The inspection process can be labor-intensive and in some cases may result in loss control inspection reports that may be excessive in length and filled with nonessential details. The present inventors have recognized opportunities to apply improved front-end data gathering and machine intelligence to make the loss control inspection process more efficient and the resulting reports more focused and user-friendly.

### SUMMARY

An apparatus, method, computer system and computer-readable data storage medium are disclosed for generating insurance company loss control inspection reports. The apparatus, method, computer system and computer-readable data storage medium may include presenting report section prompts to a wearer of a wearable data-gathering device while the wearer is at a loss control inspection site. The apparatus, method, computer system and computer-readable data storage medium also may include receiving data inputs via the wearable data-gathering device and in response to the report section prompts.

The apparatus, method, computer system and computer-readable data storage medium may further include storing the data inputs in a centralized insurance company data storage facility, and automatically editing and assembling the stored data inputs into a first report format. The apparatus, method, computer system and computer-readable data storage medium may still further include automatically editing and assembling the stored data inputs into a second report in a second report format different from the first report format. In addition, the apparatus, method, computer system and computer-readable data storage medium may make the first report available to an insurance underwriter and may make the second report available to an insurance customer that is a proprietor of the inspection site.

With intake of data directly tied to prompts for report sections, and machine editing and assembling of data into report formats, the amount of human effort involved in insurance loss control inspection and reporting may be reduced and reports may be produced directly from the data with little or no human editing required.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a block diagram of a system provided according to aspects of the present invention.

FIG. 2 is an isometric view of a wearable data-gathering device that may be part of the system of FIG. 1.

FIG. 3 is a functional block diagram representation illustrating features of the wearable data-gathering device of FIG. 2.

FIG. 4 is a functional block diagram representation of a mobile telecommunications device that may be part of the system of FIG. 1.

FIG. 5 is a block diagram representation of an insurance company central report processor of the system of FIG. 1.

FIGS. 6A and 6B together form a flow chart that illustrates a process that may be performed in the system of FIG. 1 according to aspects of the present invention.

FIG. 7 is an example output display that may be provided to a user/wearer by the wearable data-gathering device of FIGS. 2 and 3.

FIG. 8 represents visual information that may be captured by the wearable data-gathering device of FIGS. 2 and 3 in connection with a loss control inspection.

FIG. 9 shows user guidance output that may be provided to a user/wearer by the wearable data-gathering device of FIGS. 2 and 3 in accordance with aspects of the present invention.

FIGS. 10-13 illustrate further visual data capture and/or user guidance output by the wearable data-gathering device of FIGS. 2 and 3 in accordance with aspects of the present invention.

### DETAILED DESCRIPTION

The present invention provides significant technical improvements to technology utilized for data gathering and report generation in connection with insurance loss control inspections. The present invention is directed to more than merely a computer implementation of a routine or conventional activity previously known in the industry as it significantly advances the technical efficiency, access and/or accuracy of loss control inspection data gathering and report generation by implementing a specific new method and system as defined herein. The present invention is a specific advancement in the area of loss control inspection data gathering and report generation by providing technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized insurance-company operated devices and systems. For example, in the present invention the system delivers prompts to an individual who is engaged on-site in a loss control inspection. The prompts relate to specific sections of an inspection report format, and are retrieved from a central insurance company report processor and delivered to the user via a wearable data-gathering device. Input data responsive to each prompt is received via the wearable data-gathering device and is transferred to the central insurance company report processor. The central insurance company report processor receives, stores, parses and edits the data and automatically assembles it into at least two different reports having two different formats. Because the data gathering is guided by the desired report formats, the data is directly pertinent to each section of the report and automatically allocated to the relevant section. Through machine editing, virtually finished reports in two different formats can be generated with little or no human intervention beyond the data-gathering activities on-site. Thus the conventional need for subsequent human authorship of reports may be eliminated. This may result in reduced expenditure of person-hours in connection with loss control inspection and reporting, with cost savings and potentially more user-friendly reports as an output of the process.

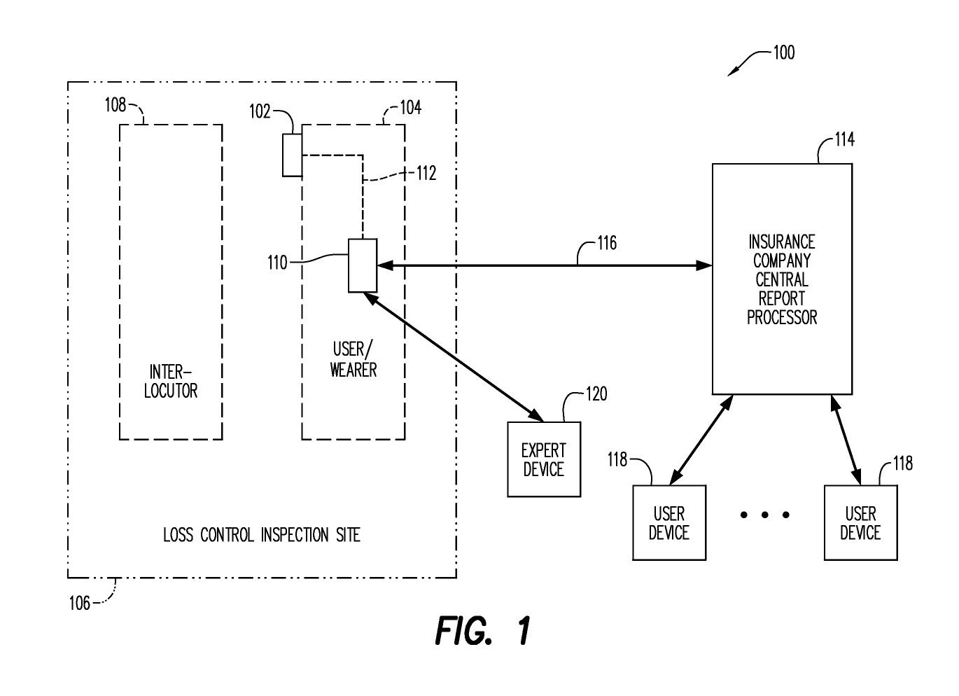

FIG. 1 is a high-level block diagram of a system 100 provided according to aspects of the present invention. The system 100 includes a wearable data-gathering device 102, such as the widely-publicized “Google Glass” device introduced by Google Inc. Example features and capabilities of the wearable data-gathering device 102 will be described below.

The wearable data-gathering device 102 is shown as being worn by an individual 104 who is a user of the wearable data-gathering device 102. The user 104 may be, for example, a loss control inspector who works for an insurance company. As is known to those who are skilled in the art, loss control inspections may be performed on the premises of an insured or prospective insured to both evaluate the risk of loss associated with the premises and to identify possible ways in which the risks may be reduced or mitigated. As is also well-known, it is customary for the loss control inspector to produce a report on the information he/she gathered during the inspection. In FIG. 1, the user 104 is shown as being present at a site 106 that is to be subject to a loss control inspection. The user may utilize/interact with the wearable data-gathering device 102 to accomplish data collection during the loss control inspection at the loss control inspection site 106.

During at least part of the inspection, the user 104 may engage in conversation with one or more individuals who are in charge of the premises, or represent the owner or occupant organization of the loss control inspection site 106. Such individuals may be referred to as interlocutors, and one interlocutor is represented at reference numeral 108 in the drawing.

The system 100 may also include a mobile device 110 that is carried by the user 104 (e.g., in the user's pocket). The mobile device 110 may be, for example, a smartphone that runs one or more suitable application programs (“apps”) that aid in the mobile device's functioning within the system 100. Example features and capabilities of the mobile device 110 will be described below. In some embodiments, one or more apps running on the mobile device 110 may program the mobile device 110 to interact with the wearable data-gathering device 102 in a manner that supports the desired functionality of the system 100. For example, in some embodiments, the mobile device 110 and the wearable data-gathering device 102 may be in at least intermittent wireless data communication with each other. The channel for such communication is schematically represented in the drawing by a dotted line 112. By way of example and not limitation, the wireless communication channel 112 may in some embodiments be implemented in accordance with the well-known Bluetooth communications standard.

The system 100 further includes a centralized insurance company report processor 114. The centralized report processor 114 may be in communication with the mobile device 110 by a communications channel 116. The communications channel 116 may be substantially conventional, and may for example be provided at least in part by a mobile communications network, which is not shown. Details of the centralized report processor 114 will be described below. At least one function of the centralized report processor 114 may be to serve as a central repository for one or more types of reports generated for or on behalf of an insurance company, which is not separately shown. For present purposes, it is assumed that the insurance company engages in issuing property and casualty insurance policies.

In some embodiments, as described below, at least some aspects of the centralized report processor 114 may be constituted by data processing/computing equipment. In some of the functionality of the centralized report processor 114, it may make reports available to users via user devices 118, which may be for example conventional personal computers, laptop computers, tablet computers, and/or browser-enabled smartphones.

As discussed further below, in some embodiments the system 100 may also include a device 120 operated by a human subject matter expert (not shown) at a location remote from the inspection site 106. The expert may have expert knowledge that is relevant to one or more aspects of the loss control inspection process. The expert may be available for consultation with the user/inspector 104 during the inspection process via a communication channel that includes the wearable data-gathering device 102, the mobile device 110 and the expert device 120. The expert device 120 may be, e.g., a smartphone, a tablet computer, or a personal computer connected to an insurance company data network (not shown).

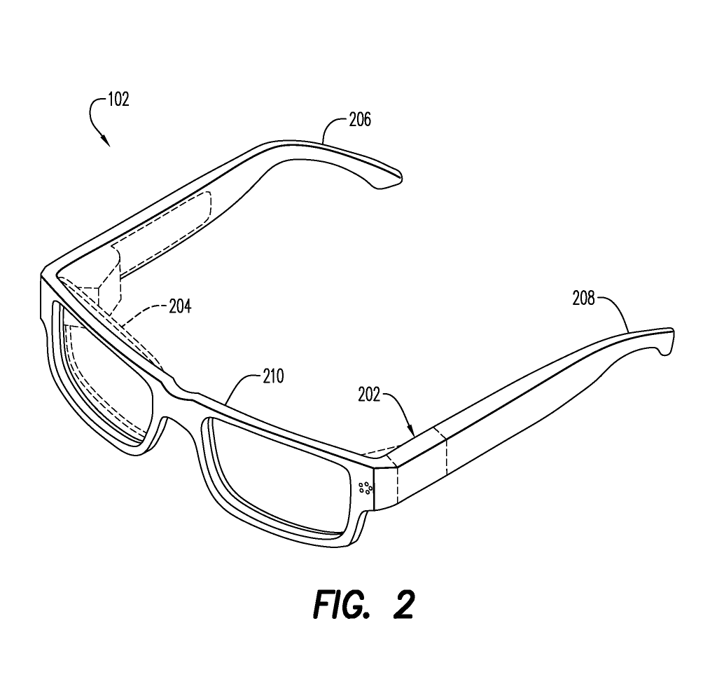

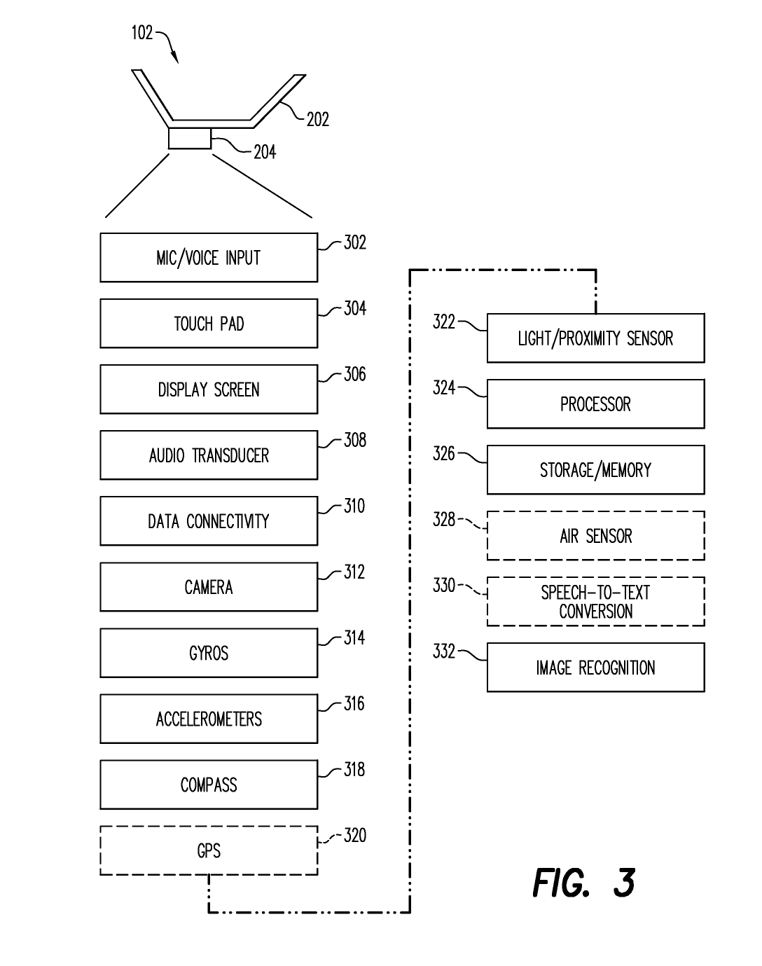

FIG. 2 is an isometric view of an example embodiment of the wearable data-gathering device 102. The wearable data-gathering device 102 may include a support frame 202. Various active/electrical/electronic/processing features 204 of the wearable data-gathering device 102 are supported on the support frame 202. An example roster of the electronic/processing features 204 will be described below in connection with FIG. 3.

Continuing to refer to FIG. 2, the support frame 202 may include a left temple piece 206 configured to rest on the wearer's left ear (not shown), and a right temple piece 208 configured to rest on the wearer's right ear (not shown). The support frame 202 may also include a central portion 210. The central portion 210 may be shaped to be supported on the wearer's nose (not shown).

Turning now to FIG. 3, the support frame 202 and electronic/processing features 204 of the wearable data-gathering device 102 are shown schematically in that drawing. Further, a sequence of blocks that will now be enumerated are used to illustrate features and/or functional blocks that may make up the electronic/processing features 204. Block 302 represents a microphone/voice/audio input device that may be one of the electronic/processing features 204. The microphone/voice input device 302 may be employed to receive voice input from the user of the wearable data-gathering device 102. The microphone/voice input 302 may also be used to receive audible input from an interlocutor of the user.

The electronic/processing features 204 may further include a touch pad 304, which may resemble, in its functional aspects, the type of touch pad provided as a pointing/dragging input device on a portable computer.

In addition, the electronic/processing features 204 may include a display 306 which provides visual output from the wearable data-gathering device 102 to the user. For example, according to specifications for the “Google Glass”, the display 306 may be implemented via projection with a resolution of 640×360. Other types of displays may alternatively be provided.

An audio transducer 308 may also be included in the electronic/processing features 204 for the purpose of providing audio output to the user, e.g., by bone conduction. The audio transducer 308 may, for example, be positioned behind the user's right ear (not shown).

Still further, the electronic/processing features 204 may include one or more data connectivity functional block(s) 310. From the earlier discussion of communications between the wearable data-gathering device 102 and the mobile device 110, it will be appreciated that the data connectivity functionality may be provided in accordance with the Bluetooth standard in some embodiments. In addition or alternatively, the data connectivity functionality may include WiFi capability and/or conventional mobile communications of the type provided by mobile devices such as smartphones or tablet computers.

The electronic/processing features 204 may also include a digital camera 312. The camera 312 may be configured to capture still images and/or moving images. It may be the case that the field of view of the camera 312 substantially overlaps the field of vision of the wearer of the wearable data-gathering device 102 when the wearer is looking straight ahead. In some embodiments, by a suitable command (e.g., a voice command) the wearer may cause the wearable data-gathering device 102 to display to the wearer the current image that would be captured by the camera if the camera were triggered to capture an image (or to start capturing moving images). By one or more additional voice commands, the wearer may trigger image capture by the wearable data-gathering device 102.

As further indicated by block 314, the features of the wearable data-gathering device 102 may include one or more gyroscopes; for example, a 3-axis gyroscope may be provided.

Still further, the electronic/processing features 204 may include a 3-axis accelerometer, represented by block 316. Also, as indicated by block 318, the features may include a compass (e.g., a 3-axis magnetometer).

In some embodiments, the electronic/processing features 204 may further include GPS (Global Positioning System) capabilities (block 320). In addition to functionality to receive the signals provided by GPS satellites, the GPS capabilities 320 may have mapping/navigation data and program instructions associated therewith (and not separately indicated in the drawing) so that the wearable data-gathering device 102 may provide conventional navigation unit functionality to the wearer.

Another feature/function that may be included among the electronic/processing features 204 is represented by block 322, and may constitute a light sensor/proximity sensor.

Moreover, the electronic/processing features 204 may include a processor 324. The processor 324 may be the over-all control unit for the wearable data-gathering device 102. The processor 324 may be a conventional microprocessor or may be a processor of special design but nevertheless may reflect conventional hardware design principles for microprocessors and/or embedded control circuits for miniaturized intelligent devices. The processor 324 may be programmable by program instructions, which may be stored in storage and/or memory devices (block 326) that are also part of the electronic/processing features 204 and in communication with the processor 324. The program instructions may include an operating system and/or one or more application programs, which are not indicated in the drawings apart from the storage/memory block 326. The program instructions may include one or more drivers for other constituent elements of the wearable data-gathering device 102. The programming of the processor 324 may be such that applications (“apps”) may be downloadable to the wearable data-gathering device 102 from an “app store” or the like and then runnable on the processor 324. Functionality provided by the processor 324 under control of the program instructions and in accordance with aspects of the present invention will be described further below.

In some embodiments, the electronic/processing features 204 of the wearable data-gathering device 102 may also include an air sensing functional block 328. The air sensor 328 may be configured to detect one or more vapor components or other characteristics of the ambient air at the current location of the wearable data-gathering device 102.

Block 330 highlights a further capability that may be included in some embodiments of the wearable data-gathering device 102, namely speech-to-text conversion. This may be implemented, for example, via suitable programming of the processor 324, and may represent an extension of the capabilities of the wearable data-gathering device 102 to respond to voice commands. It will be appreciated that the speech-to-text conversion capability 330, if present, may be applied to speech input from the wearer provided via the microphone 302. In addition or alternatively, the wearable data-gathering device 102 may have capabilities for transmitting speech input from the wearer to the mobile device 110 (FIG. 1), potentially for conversion to text at the mobile device 110.

In some embodiments, the electronic/processing features 204 may include image recognition functionality (block 332), to allow the wearable data-gathering device 102 to identify, detect and analyze objects contained in images captured by the camera 312.

The above enumeration of functionality of the wearable data-gathering device 102 is intended to be by way of example only. Particular features referred to above may be omitted in some embodiments of the wearable data-gathering device 102 and/or other features/functionalities may be present in some embodiments. The wearable data-gathering device 102 need not have a form factor that resembles a set of eye glasses; rather the wearable data-gathering device 102 may take the form of another sort of wearable intelligent device.

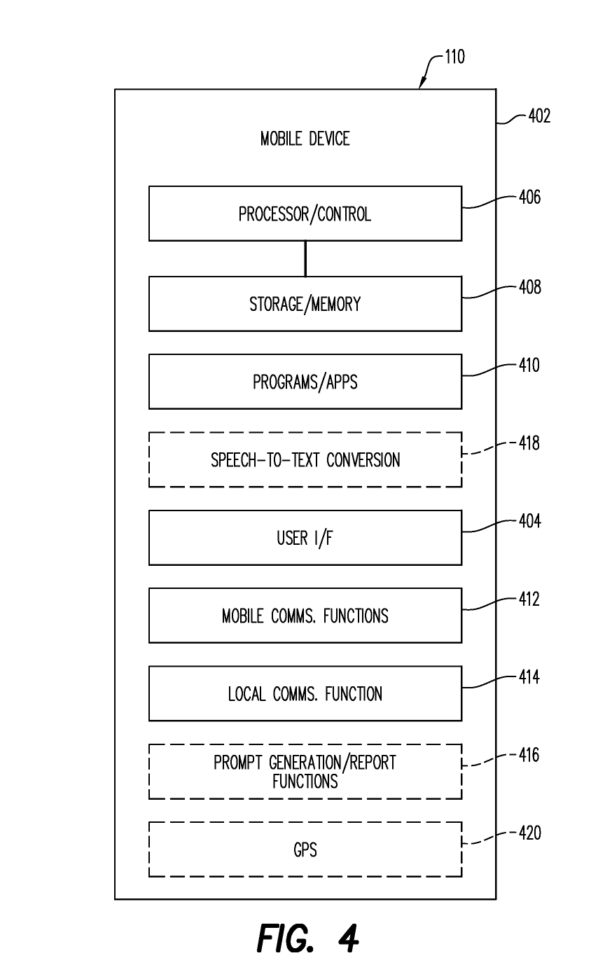

FIG. 4 is a functional block diagram representation of an example embodiment of the mobile device 110.

In one example embodiment, the mobile device 110 may be a typical smartphone, and thus may be entirely conventional in its hardware aspects and also in many software aspects. In addition to conventional programming of the mobile device 110, it may also be programmed suitably to allow it to interact with the wearable data-gathering device 102 and the centralized report processor 114 maintained by or for the insurance company referred to above. The manner and purpose of those interactions may be as described herein. In some embodiments, the mobile device 110 may serve a data transmission relay function in one or both directions between the wearable data-gathering device 102 and the centralized report processor 114. A brief overview of salient aspects of the mobile device 110 will now be provided, while noting that many of those salient aspects may be conventional.

The mobile device 110 may include a conventional housing 402. In many embodiments, the front of the housing is predominantly constituted by a touchscreen (not separately shown), which is a key element of the user interface 404 of the mobile device 110.

The mobile device 110 further includes a conventional mobile processor/control circuit 406, which is contained within the housing. Also included in the mobile device 110 is a storage/memory device or devices (reference numeral 408). The storage/memory devices are in communication with the processor/control circuit 406 and may contain program instructions to control the processor/control circuit to manage and perform various functions of the mobile device 110. As is well-known, such functions include operation as a mobile voice communication device via interaction with a mobile telephone network (not shown). Further conventional functions include operation as a mobile data communication device, and also as what is in effect a pocket-sized personal computer, via programming with a number of application programs, or “apps”. (The apps are represented at block 410 in FIG. 4, and may in practice be stored in block 408, to program the processor/control circuit 406 in myriad ways.) The above-referenced mobile communications functions are represented by block 412, and in addition to programmed control functions, the mobile communications functions also rely on hardware features (not separately shown) such as an antenna, a transceiver circuit, a microphone, a loudspeaker, etc.

Block 414 in FIG. 4 represents features that enable the mobile device 110 to engage in local communications, e.g., via operation in accordance with the Bluetooth and/or WiFi standards. Thus block 414 may represent the mobile device side of the communication channel 112 shown in FIG. 1. Accordingly, block 414 may enable exchange of data communication with the wearable data-gathering device 102.

Via one or more apps or other suitable programming of the processor 406, the mobile device 110 may also feature functionality (block 416) that allows the mobile device to generate or relay prompts to the wearable data-gathering device 102 such that the user may be guided through a loss control inspection process and accompanying data gathering for a report of such an inspection. Details will be provided below concerning the type of guidance and report generation activities that may be enabled by block 416.

Still further, the mobile device 110 may include speech-to-text conversion functionality (block 418), as alluded to above. Also, the mobile device 110 may incorporate GPS/navigation functions (block 420), such as are often provided in conventional smartphones.

It will be appreciated that the blocks depicted in FIG. 4 as processors of the mobile device 110 may in effect overlap with each other, and/or there may be functional connections among the blocks which are not explicitly shown in the drawing.

It has been suggested hereinabove that the mobile device 110 may be embodied as a smartphone, but this assumption is not intended to be limiting, as the mobile device 110 may alternatively, in at least some cases, be constituted by a tablet computer that has mobile communication capabilities, or by other types of mobile computing devices.

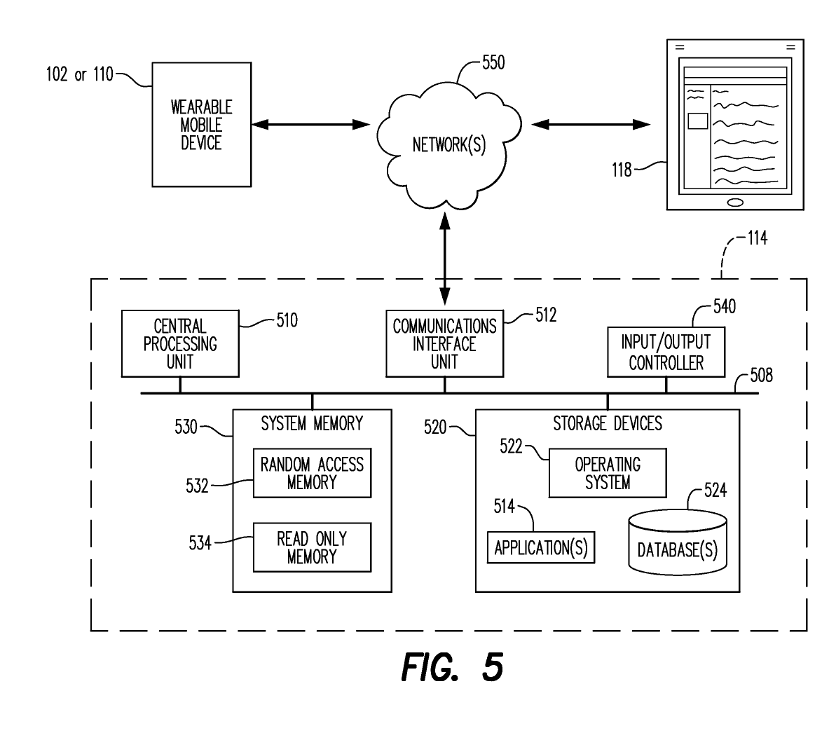

FIG. 5 is a block diagram representation of an example embodiment of the centralized report processor 114, together with some other aspects of the system 100. Although the centralized report processor 114 may in some embodiments be implemented by suitably programmed general purpose data processing equipment, nevertheless in other embodiments the centralized report processor 114 may be constituted by special purpose hardware designed and configured to provide functionality as described herein. It is well within the capabilities of those who are skilled in the art to implement the special purpose equipment referred to herein based on the present functional description of the system 100.

In the example centralized report processor 114 depicted in FIG. 5, a central processing unit or processor 510 executes instructions contained in programs, including for example application software programs 514, stored in storage devices 520. The application software programs 514 may provide functionality as described herein to implement an embodiment of the centralized report processor 114 and/or to provide functionality of the centralized report processor 114 as described herein. Processor 510 may provide the central processing unit (CPU) functions of a computing device on one or more integrated circuits. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Storage devices 520 may include suitable media, such as optical or magnetic disks, fixed disks with magnetic storage (hard drives), tapes accessed by tape drives, and other storage media. Processor 510 communicates, such as through bus 508 and/or other data channels, with communications interface unit 512, storage devices 520, system memory 530, and input/output controller 540. System memory 530 may further include non-transitory computer-readable media such as a random access memory 532 and a read only memory 534. Random access memory 532 may store instructions in the form of computer code provided by one or more application(s) 514 to implement teachings of the present invention. The centralized report processor 114 further includes an input/output controller 540 that may communicate with processor 510 to receive data from user inputs such as pointing devices, touch screens, and audio inputs, and may provide data to outputs, such as data to video drivers for formatting on displays, and data to audio devices.

Continuing to refer to FIG. 5, storage devices 520 are configured to exchange data with processor 510, and may store programs containing processor-executable instructions, and values of variables for use by such programs. Processor 510 is configured to access data from storage devices 520, which may include connecting to storage devices 520 to obtain or read data from the storage devices, or place or store data into the storage devices. Storage devices 520 may include local and network accessible mass storage devices. Storage devices 520 may include media for storing operating system 522 and mass storage devices such as storage 524 for storing one or more databases, including one or more databases of reports, including reports generated in connection with loss control inspections performed for the insurance company.

Communications interface unit 512 may communicate via one or more network(s) 550 with other devices, such as user devices 118 (of which one is depicted in FIG. 5) and/or the above-described wearable data-gathering device 102 and/or mobile device 110. The network(s) 550 may at least in part be constituted by one or more mobile telecommunication networks, an insurance company intranet or other internal network and/or the internet.

Continuing to refer to FIG. 5, the communications interface unit 512 may communicate with centralized computing resources of the insurance company, which are not expressly shown in the drawing. As noted before, the centralized report processor 114 may be constituted by special purpose hardware or alternatively may be configured in a distributed architecture of general purpose data processing equipment, wherein databases and processors are housed in separate units or locations. Some such servers may perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SASTM, ATP, Bluetooth, GSM and TCP/IP. The network(s) 550 may be or include wired or wireless local area networks and wide area networks, and may be implemented at least in part via communications between networks, including over the Internet.

One or more public cloud, private cloud, hybrid cloud and cloud-like networks may also be implemented, for example, to handle and conduct processing of one or more tasks, transactions, operations or processes as described herein as aspects of the present invention. Cloud based computing may be used herein to handle any one or more of the application, storage and connectivity requirements of the centralized report processor 114 and aspects of the present invention. For example, one or more private clouds may be implemented to handle web hosting, and data processing and storage in accordance with aspects of the present invention. Furthermore, any suitable data and communication protocols may be employed to accomplish the teachings of the present invention.

With reference still to FIG. 5, communications interface 512 may be used for receiving and/or transmitting data relating to reports generated in the centralized report processor 114 based on loss control site inspections. Processor 510 may execute program instructions, such as program instructions provided by application(s) 514 to receive (via the communications interface 512) and to store (in database storage 524) the data relating to loss control inspection reports. Also, as will be seen, the processor 510 may execute program instructions to automatically assemble and distribute such reports.

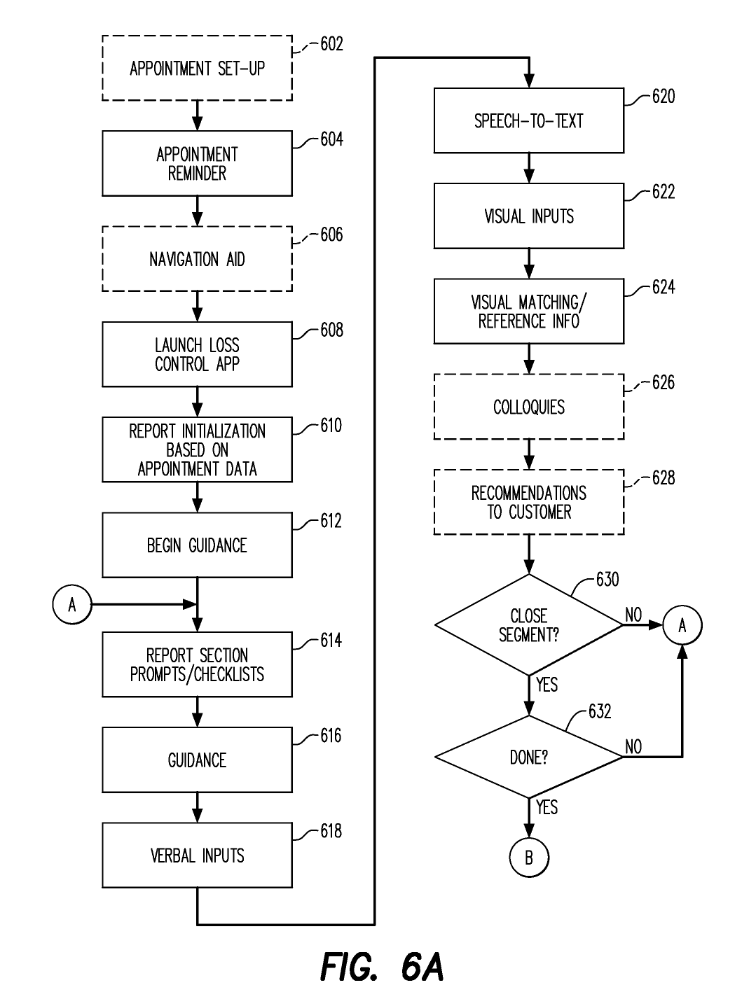

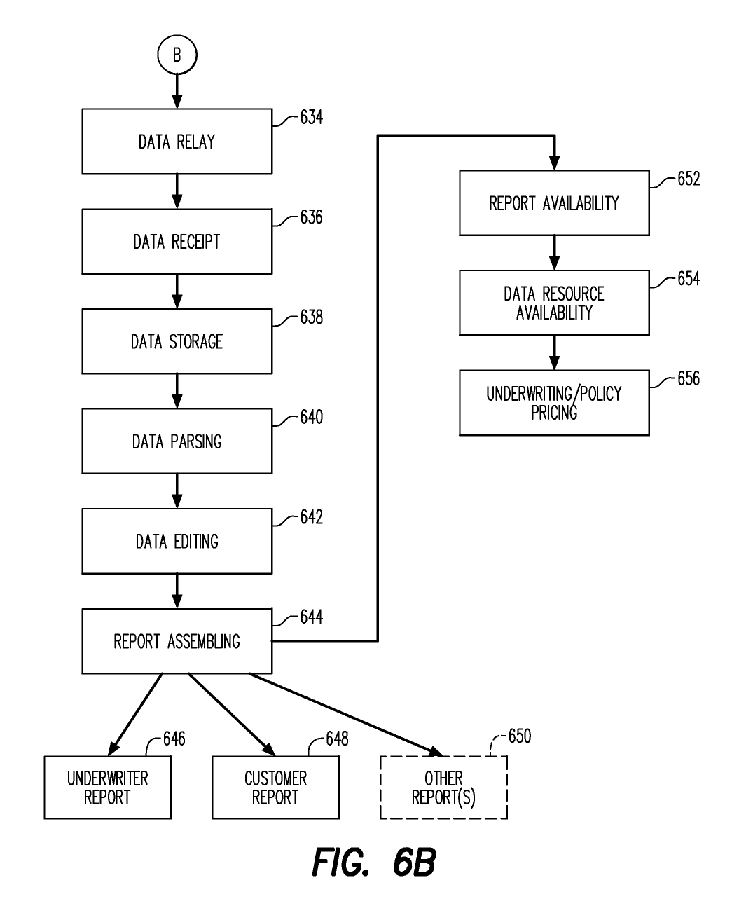

FIGS. 6A and 6B together form a flow chart that illustrates a process that may be performed in the system 100 according to aspects of the present invention.

At 602 in FIG. 6A, an appointment is set up in the system 100 for the user 104 (FIG. 1) to visit a customer's premises for the purpose of performing a loss control inspection. As used herein and in the appended claims, the terms “customer” or “insurance customer” refer to a company or other entity that is a current or prospective holder of an insurance policy issued by the insurance company that operates the system 100.

As part of the set up of the appointment, basic information may be entered in a file, including the name of the customer, the street address for the site to be inspected, contact information for the customer (e.g., mailing address, email address, telephone number, contact name, etc.), information that identifies the type of business or activity carried out by the customer and/or at the location of the premises (i.e., describing the nature of the premises to be inspected). The set up information for the appointment also identifies the individual who is to perform the loss control inspection and places the appointment on the individual's electronic calendar, together with one or more suitably timed reminders.

Still other information that may be included in the appointment set up may include additional data elements that may be needed for the report(s) to be produced. This may include information about the inspector, including phone number, employee i.d. number, etc. and similar information about the individual (e.g., an underwriting specialist) who requested the inspection. Additional data elements for the report(s) may include identification and contact information for an insurance broker who has brought or is seeking to bring in the business, as well as name and/or other information concerning other insurance company employees who are involved in the account or prospective account. The type(s) of insurance coverage sought may also be indicated. There may also be information recorded as to one or more regulatory standards that may be applicable to the activities conducted at the inspection site.

In some cases a phone or written (or online) survey may previously have been conducted with respect to the customer, and information generated from such survey(s) may also be stored in association with the appointment set up. It should be understood that the outcome of the inspection will be one or more reports and/or other compilations of information, so that the appointment set up information and information associated therewith may serve as inputs to the reports that are to be produced.

At block 604, at one or more appropriate times, the system 100 may provide a reminder to the user 104 concerning the scheduled appointment for a loss control inspection at the customer's premises. This may occur via the wearable data-gathering device 102 and/or via the mobile device 110.

At block 606, possibly in response to a request from the user 102, the wearable data-gathering device 102 and/or the mobile device 110 may provide navigational guidance to the user 104 to aid the user in navigating to the inspection site 106 (i.e., to the customer's premises).

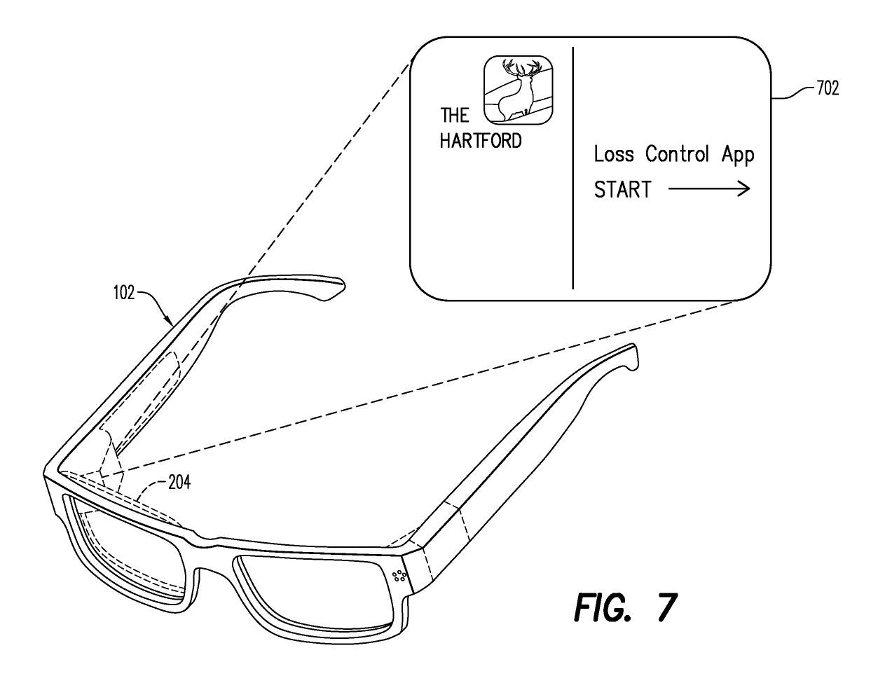

At 608, the user 104 may elect to launch the app on the wearable data-gathering device 102 and/or the mobile device 110 that will guide the user 104 through the required process for the loss control inspection. Presumably this will occur at a time when the user 104 has arrived at the inspection site. The launching of the loss control inspection app may be indicated, for example, by a display output like that shown at 702 in FIG. 7, which may be presented to the user 104 via the display processor 306 of the wearable data-gathering device 102.

Upon launching of the loss control inspection app, block 610 of FIG. 6A may take place. At block 610, the system 100 (e.g., the centralized report processor 114) may initialize the report that is to be generated from the inspection that is being conducted by the user 104. The various sections of the report may all be created in accordance with a predetermined format for such reports. The format may be one that applies for all loss control inspection reports, or the format may be one that has been prescribed for the particular type of premises that the user 104 is inspecting. Some sections of the report may be immediately populated by the centralized report processor 114 with information that was previously stored regarding or in association with the appointment for the loss control inspection. For example, information regarding the inspector (i.e., the user 104), the customer, the broker, and other relevant individuals may be loaded into the appropriate sections of the report. Information obtained from preliminary survey activity may also be automatically incorporated in the report at this point by the centralized report processor 114. Other sections of the report are currently shells at this point, awaiting information to be gathered/input during the loss control inspection.

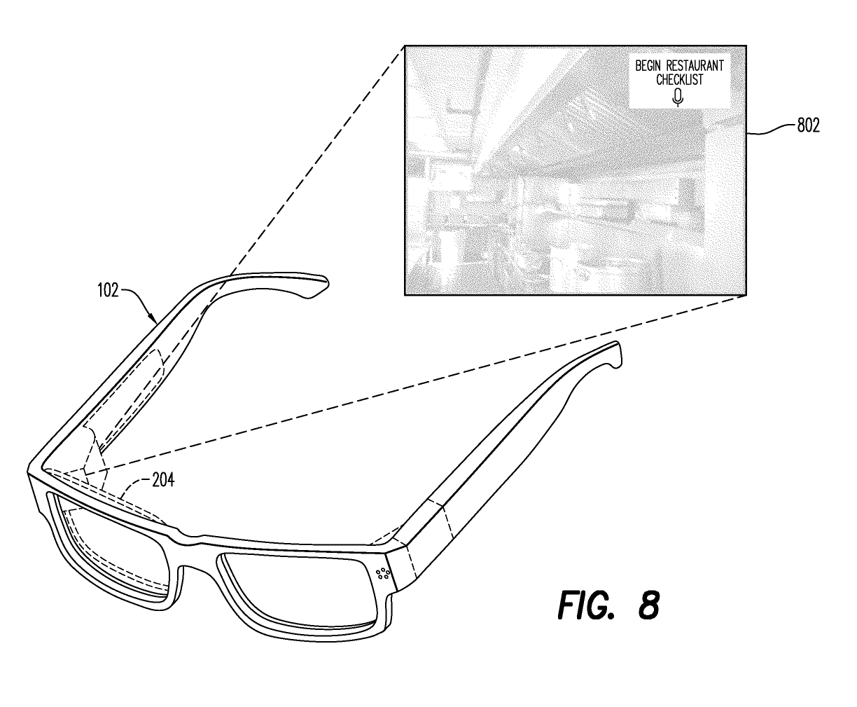

For purposes of the ensuing description of FIGS. 6A/6B, it is assumed that the loss control inspection site 106 is a restaurant and that the system 100 will guide the user 104 through a predetermined data gathering process that is tailored to be appropriate for a loss control inspection of such a facility. It will also be assumed that a predetermined report format or formats have also been stored in the centralized report processor 114, where the report format(s) also are tailored to loss control issues relating to that type of facility. A view of the restaurant kitchen, for example, may be provided as shown at 802 in FIG. 8 (as captured by the wearable data-gathering device 102).

At block 612 in FIG. 6A, the wearable data-gathering device 102/mobile device 110/loss control inspection app may begin guiding the user 104 as to what the user 104 is required to do to perform the loss control inspection. The form of the guidance may be, for example, visual display of information and/or audio output of information from the wearable data-gathering device 102 to the user 104. The guidance may be provided in a manner such that it relates to one section of the inspection report after another, with all information to be gathered/input for each section before the guidance moves on to the next section. In some embodiments, the guidance (i.e., visual and/or audio prompts) may originate section by section from the centralized report processor 114, and then may be relayed from the centralized report processor 114 to the wearable data-gathering device 102 via the mobile device 110. It may be the case with respect to each report section that one or more prompts require the user's attention and compliance in sequence to complete data gathering for the report section in question. In some embodiments, prompts may be provided to the user 104 in an order that does not directly follow the order of sections in a report format. The blocks following block 612 in FIG. 6A will now be discussed to provide additional details about how the data gathering and input process occurs for each report section or series of prompts.

Block 614 in FIG. 6A represents an initial prompt or series of prompts and/or presentation to the user 104 of a checklist of information to be obtained/input into the wearable data-gathering device 102. As noted above, the prompts/checklists may be presented to the user 104 via the wearable data-gathering device 102. In addition to prompts, the wearable data-gathering device 102 may provide background and guidance to the user 104, as represented by block 616. The guidance, the prompts and the checklist(s) may all be relevant to one or more current sections of the report for which information is currently being collected.

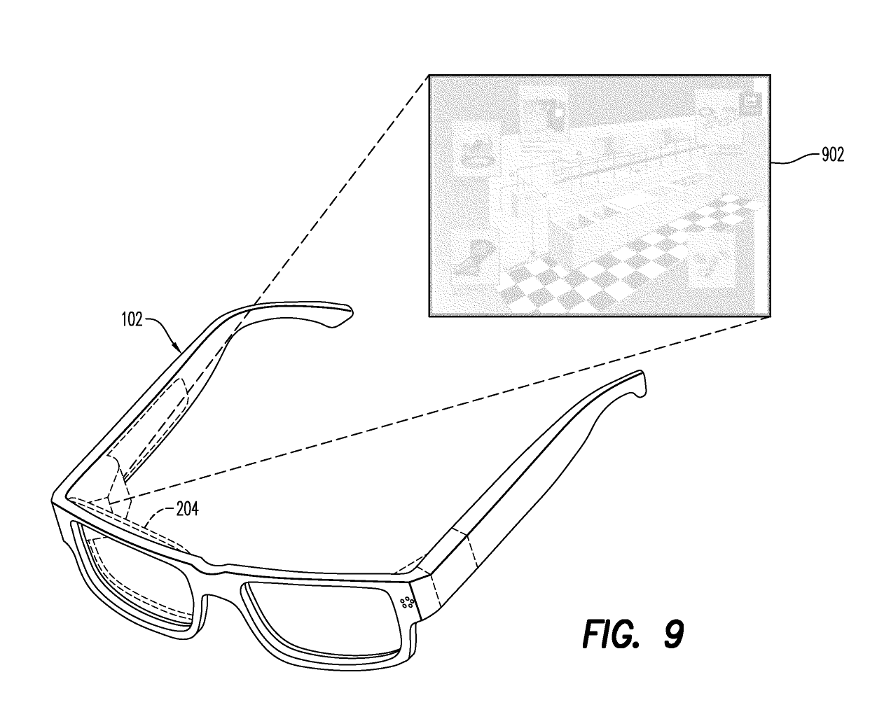

In some embodiments, for example, the guidance to the user 104 may include a virtual map of a typical facility of the type that is being inspected. Then one particular segment of the virtual map may be initially highlighted to indicate to the user 104 that he/she should proceed to that portion of the premises/inspection site. Assuming that the first location to be inspected is the restaurant kitchen, that portion of the virtual map may be highlighted first. A prompt may instruct the user 104 to say something like “in the kitchen” when he/she has reached the kitchen. When the user utters those words, the wearable data-gathering device 102 may respond by presenting a screen display such as that shown at 902 in FIG. 9.

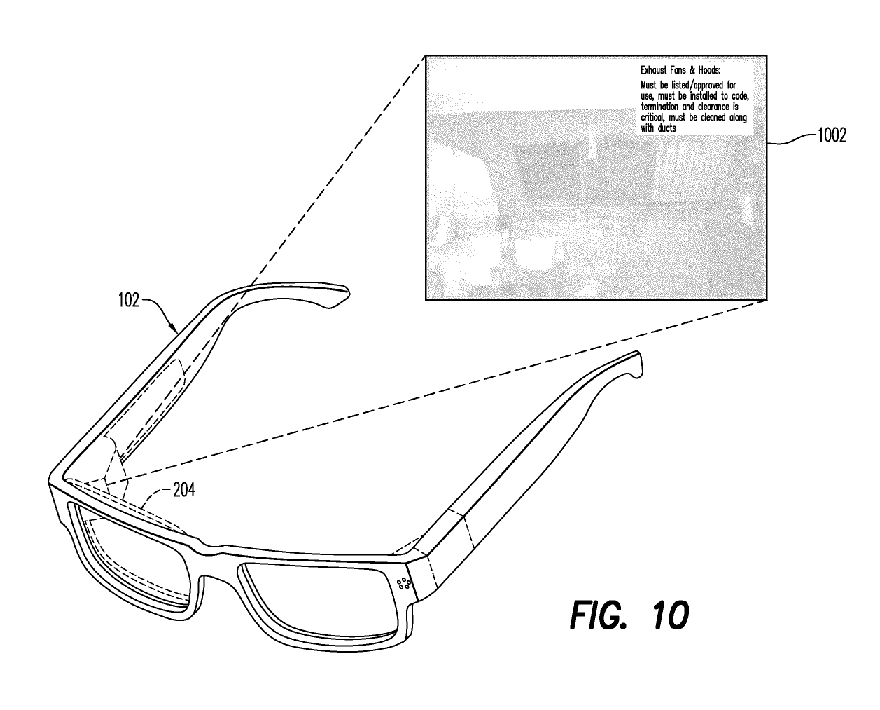

It will be observed that the screen display 902 of FIG. 9 is a virtual illustration of a typical restaurant kitchen. Again, portions of the screen display may be highlighted in order, one by one, to guide the user 104 through the required inspection process as it relates to the kitchen. When each display portion is highlighted, the user may issue a response such as, “Ready for guidance.” The wearable data-gathering device 102 may then pose one or more questions or prompts relevant to the current portion of the kitchen. For example, the wearable data-gathering device 102 may present a display like that shown at 1002 in FIG. 10 to the user 104, in which the wearable data-gathering device 102 informs the user 104 about what standard(s) is(are) applicable to the exhaust fans and hoods for the cooking area. The wearable data-gathering device 102 may then ask the user 104 to indicate whether the standard(s) is(are) met. As indicated at block 618 in FIG. 6A, the user 104 may speak a verbal response into the microphone 302 of the wearable data-gathering device 102 (e.g., “yes” or “no”). The spoken verbal response may be converted to text (block 620, FIG. 6A), either at the wearable data-gathering device 102 or at the mobile device 110. The resulting text becomes part of the data to be used in assembling a pertinent section or sections of the inspection report.

In addition or alternatively, the wearable data-gathering device 102 may pose an open ended question or questions to the user 104 (e.g., “Generally describe the kitchen area,” “Add any further comments,” etc.). Again the spoken response from the user 104 may be converted to text and stored for potential use in assembling the pertinent section(s) of the inspection report.

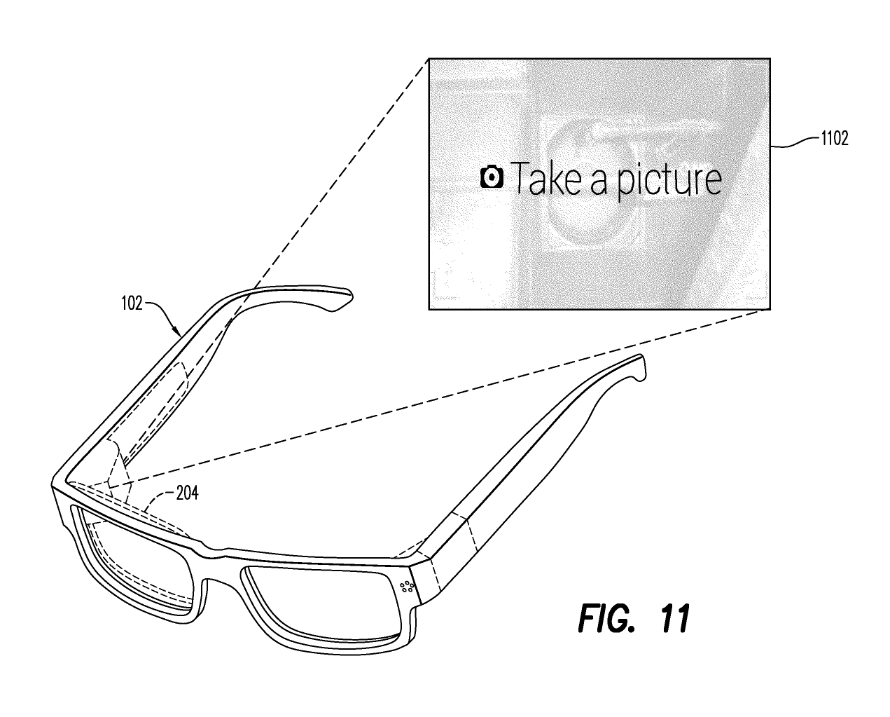

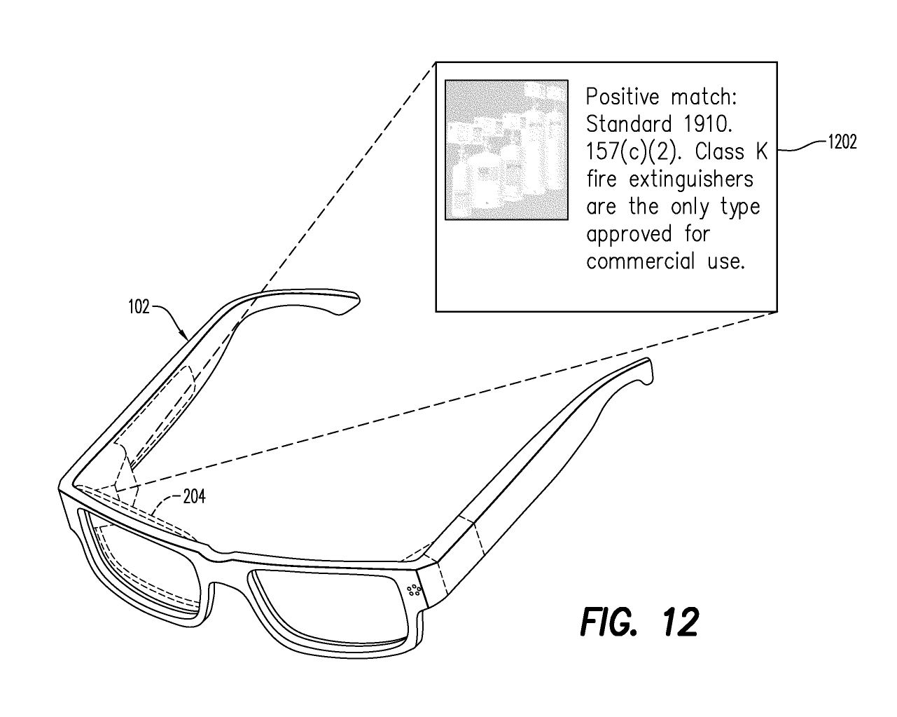

For one or more portions of the inspection site, and/or one or more sections of the inspection report, the wearable data-gathering device 102 may request that the user 104 provide visual inputs, such as still or moving images (block 622, FIG. 6A). For example, the wearable data-gathering device 102 may prompt the user 104 to take a picture of a fire extinguisher that is present in the kitchen of the inspection site. The user 104 may then approach and turn to face the fire extinguisher and may issue a voice command such as, “Take picture.” The result may be like the image presented at 1102 in FIG. 11. The system 100 may then seek (block 614, FIG. 6A) to match the image of the fire extinguisher with reference images that represent appropriate and inappropriate fire extinguishers for the current application (i.e., for a restaurant kitchen cooking area). An example output screen shown at 1202 in FIG. 12 illustrates the type of reference response the wearable data-gathering device 102 may provide when the system 100 finds a match for the fire extinguisher image captured at block 622. The visual input and/or the resulting search results and reference information may also be stored as input for the pertinent section(s) of the inspection report. Suitable data may be associated with each stored image or video clip, such as date and time of capture, location (e.g., in terms of navigation aid data and/or in terms of the portion of the inspection site 106 that the image clip documents), relevant report section, inspection identification number, etc. The image/video clip may also be stored in association with the stored text that is relevant to the report section in question.

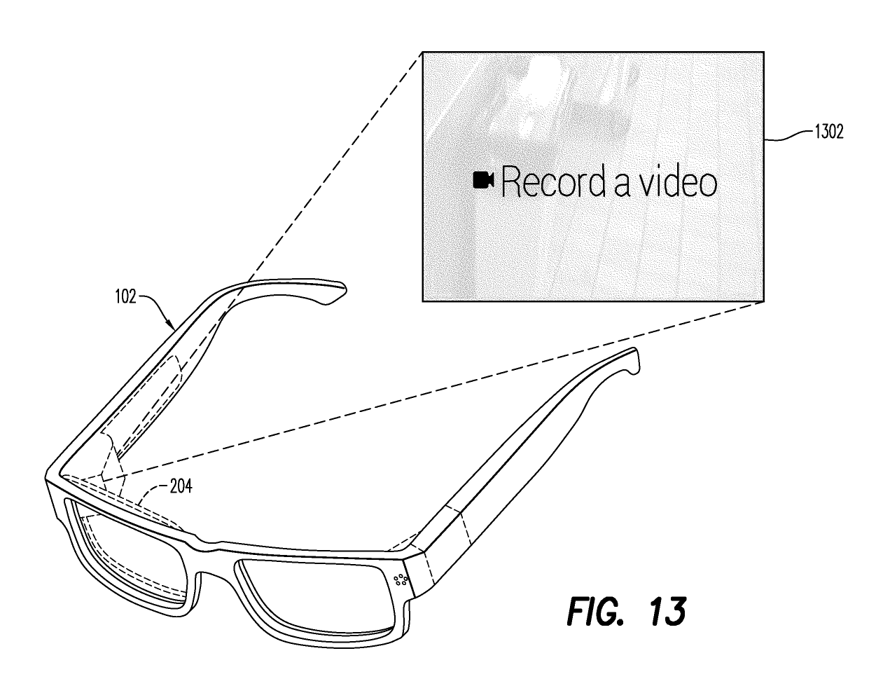

The prompts from the wearable data-gathering device 102, at least for some sections of the report, may include an open-ended prompt to provide other relevant information. The user 104 may respond with something like, “Decline”, if there is nothing relevant to add. But in other situations, the user 104 may provide further data input. For example, if the user 104 spots an overflowing, undersized wastepaper basket, he/she may provide spoken-word input to that effect, while also capturing a still or moving image of the wastepaper basket, as shown for example at 1302 in FIG. 13.

In some embodiments, the system 100 may facilitate access by the user 104 to experts or virtual experts in real time while the loss control inspection is occurring. For example, the user 104 may encounter a condition at the inspection site 106 that causes the user 104 to seek expert input in terms of how to report or interpret the condition. The user may accordingly utter a command such as, “Get expert” into the microphone 302 of the wearable data-gathering device 102. In response, the system 100 may immediately place the user 104 in touch with a human expert via the above-mentioned expert device 120 (FIG. 1). The system 100 may infer what category of expertise is needed from the context of the ongoing inspection process (i.e., from the current report section or portion of the inspection process for which the user 104 is currently being prompted to gather data). In some embodiments, the system 100 may prompt the user 104 to specify by voice input what sort of expert the user 104 wishes to consult. In some embodiments, the user 104 may communicate his/her query to the expert via speech that the system 100 converts to text and forwards to the expert. In some embodiments, an image or image(s) or video clip(s) taken at the inspection site 106 by the wearable data-gathering device 102 may be sent by the system 100 to the expert to accompany/illustrate the query from the user 104.

In some embodiments, the centralized report processor 114 may incorporate at least some aspects of one or more expert systems pertinent to issues that may be faced during loss control inspections. When the user 104 requests expert assistance during an inspection, the system 100 may determine whether there is available a virtual expert that is pertinent to the current context (i.e., the current subject of prompts) of the loss control inspection. If such is the case, the system 100 may offer to the user 104 an opportunity to query a virtual expert (expert system) that resides within the centralized report processor 114.

Referring again to FIG. 6A, in some embodiments and/or for some sections of the inspection report, the wearable data-gathering device 102 may prompt the user 104 to interview one or more interlocutors 108 (FIG. 1)—i.e., representatives of the customer—and the wearable data-gathering device 102 may feed questions to the user 104 that he/she is to ask of the interlocutor(s). The resulting colloquies (block 626, FIG. 6A) may be captured via the microphone 302 of the wearable data-gathering device 102. Again, speech-to-text conversion may be applied at the wearable data-gathering device 102 or the mobile device 110 (e.g., with respect to the spoken utterances from either or both of the user 104 and the interlocutor(s) 108), and the resulting text data may be stored as potential input for the pertinent section(s) of the inspection report. The wearable data-gathering device 102/mobile device 110 may use voice recognition to identify who is speaking so that the resulting text input is attributed to either the user 104 or the interlocutor 108, and the resulting text input may be tagged accordingly.

Also in some embodiments, and/or with respect to some portions of the loss control inspection process, verbal and visual and/or other data captured via the wearable data-gathering device 102 may cause the system 100 to identity loss prevention/mitigation opportunities that are applicable to the inspection site 106. In such cases, the system 100 may generate output that the user 104 may share with the interlocutor 108 in the form of recommendations to the customer (FIG. 6A, block 628). These recommendations may, for example, include best practices that the system 100 (e.g., the centralized report processor 114) has stored and has noted are not present in the inspection site as described by the data gathered via the wearable data-gathering device 102. In some embodiments, the recommendation information may be in a form such that it may be transferred by short-range radio communication from the wearable data-gathering device 102 and/or the mobile device 110 to the interlocutor's mobile device (which is not shown). In addition or alternatively, the user 104 may be prompted by the wearable data-gathering device 102 to impart the recommendation information orally to the interlocutor 108.

In a process step that may take place, but is not explicitly represented in FIG. 6A, the wearable data-gathering device 102 may gather data indicative of air quality and/or one or more constituent portions of the ambient air at the current location of the wearable data-gathering device 102. For example, this process step may occur automatically, based on the inspection process protocol as relayed to the wearable data-gathering device 102 from the centralized report processor 114 at a time or times when the user 104 has indicated that he/she is at a particular portion of the inspection site 106. The resulting air sensing data may be relayed by the mobile device 110 to the centralized report processor 114 for inclusion in the pertinent inspection report section(s). In some embodiments, the result of the air sensing may cause the system 100 to prompt the user 104 to engage in additional inspection/data gathering activities that would not be required in the absence of such an air sensing result.

In some embodiments, the wearable data-gathering device 102 may, via the camera 312, examine and analyze the appearance of wall surfaces at the inspection site 106 to attempt to detect possible adverse conditions reflected in deposits of material on the wall surfaces.

At decision block 630 in FIG. 6A, the system 100 may determine whether the data gathering for the current segment of the inspection process is complete. If not, the process of FIG. 6A may loop back to continue with one or more of the blocks 614-628 as described above. However, if a positive determination is made at decision block 630 (i.e., if the process segment is complete), then the process of FIG. 6A may advance from decision block 630 to decision block 632.

At decision block 632, the system 100 may determine whether the entire inspection process has been completed. If not, the inspection process moves on to the next data gathering segment, and the process of FIG. 6A loops back to block 614. Accordingly, the system 100 may proceed to prompt the user 104, step by step, via the wearable data-gathering device 102, to input/gather the required data for the next segment of the inspection process.

Considering again decision block 632, if a positive determination is made at that point in the process (i.e., if the inspection process has been completed), then the process may advance from decision block 632 in FIG. 6A to block 634 in FIG. 6B. At block 634, the mobile device 110 may relay the data gathered for the current or just completed segment of the inspection process to the centralized report processor 114. Then, at block 636 in FIG. 6B, the centralized report processor 114 may receive the data relayed to it from the mobile device 110. Next, at block 638, the centralized report processor 114 may store the data received at 636 in an appropriate manner for possible inclusion in the relevant section(s) of the inspection report.

At block 640, the centralized report processor 114 may parse the stored data to at least partly determine the content of the stored data and to determine the suitability of the stored data for inclusion in the relevant section(s) of the report. At block 642, the centralized report processor 114 may edit the data relevant to the current report section so as to arrive at a completed, edited version of the report section.

In some embodiments, blocks 640 and 642 may involve the centralized report processor 114 performing a content analysis on text derived from spoken utterances (by the user 104 and or the interlocutor 108) captured via the wearable data-gathering device 102. The centralized report processor 114 may determine which portions of the text constitute main or important points, and which portions of the text constitute secondary points or irrelevant information. The centralized report processor 114 may operate such that only text corresponding to main or important points may be included in the relevant report section. Secondary or irrelevant text may be edited out of the report section.

At block 644, when the centralized report processor 114 has received and edited the data for all the sections of the report, the centralized report processor 114 may assemble the complete report from the report sections resulting from the edited data. At least some sections of the report may contain visual data gathered and received in connection with corresponding portions of the loss control inspection process.

It should be understood that at least some portion of the processing represented by blocks 634-644 (FIG. 6B) may overlap in time with the processing represented by blocks 614-628 (FIG. 6A). For example, data may be relayed to the centralized report processor 114, and received and stored by the centralized report processor 114, as it is being gathered at the inspection site and/or while further data for the same report section or sections is being gathered at the inspection site.

Up to this point, the discussion has primarily referred to the inspection report in the singular. Nevertheless, in some embodiments, the centralized report processor 114 may generate two or more reports and/or additional data resources from the data gathered by the wearable data-gathering device 102, and relayed to and edited by the centralized report processor 114. Each report generated by the centralized report processor 114 may be different in format from the other or others. Each report format may consist of a number of sections that are appropriate for the intended purpose and/or audience for the report. Where the data gathering process referred to above (e.g., blocks 614-628, FIG. 6A) was carried out report-section-by-report-section, the process may have involved sections for one report format interspersed with sections for one or more other report formats. In some embodiments, two or more report formats may have sections in common, or at least sections that share some of the same input data.

In some embodiments, the manner in which the centralized report processor 114 edits input text data may vary, depending on the type of report. For example, for a report that has a less sophisticated intended audience, the editing protocol performed by the centralized report processor 114 may be geared to produce more concise edited output.

For example, as indicated by block 646 in FIG. 6B, one report generated by the centralized report processor 114 may be an underwriter report—i.e., a report that is suitable for informing an insurance underwriter about the results of the loss control inspection. In some embodiments, the report sections may correspond to those of conventional reports prepared by loss control inspectors using a word processing program and based on notes taken by the inspectors. However, in accordance with aspects of the present invention, the underwriter report as generated by the centralized report processor 114 may be much more concise, user-friendly and readable than a typical conventional report, because the automated editing of text and/or other data by the centralized report processor 114 may prevent its underwriter report from containing the sort of often verbose narrative portions and/or transcriptions of notes that are frequently found in reports prepared in a conventional manner by loss control inspectors.

Block 648 in FIG. 6B represents generation by the centralized report processor 114 of a report to be provided to the customer (i.e., to the proprietor of the inspection site 106). In some embodiments, the format for the customer report generated at block 648 may result in a simpler, less detailed report than the underwriter report generated at 646. The customer report may have a format that includes a number of sections that is different from the number of sections in the format for the underwriter report. In some embodiments, the centralized report processor 114 may automatically insert into the customer report definitions of terms used in the customer report in order to aid the customer in understanding the customer report. The underwriter report may lack such definitions, as the terms used by the loss control inspector may all be well known to the underwriter. In some embodiments, the customer report may include recommendations for reducing or mitigating risks of loss at the customer's premises. In some cases, these recommendations may include or repeat recommendations provided to the customer directly by the loss inspector during the loss control inspection, e.g., via information provided through the wearable data-gathering device 102.

In some embodiments, as indicated by block 650, the centralized report processor 114 may generate additional loss control inspection reports in additional formats, based on the data gathered at the inspection site 106 via the wearable data-gathering device 102.

In some embodiments, the reports automatically generated by the centralized report processor 114 may be of sufficiently high quality that little or no human editing is required before providing the reports to the intended recipients. The automatic report generation by the centralized report processor 114, based on section-by-section data gathering via the wearable data-gathering device 102, may result in a significant reduction in the number of hours required to be spent by the loss control inspector to arrive at a completed report. The total or near absence of need for editing of the report by the loss control inspector also may contribute to savings in person-hours required to generate loss control inspection reports. With this saving in person-hours, the overall cost of conducting loss control inspections may be substantially reduced. Consequently, the insurance company that operates the system 100 may find it to be economically feasible to extend its inspection and marketing efforts to smaller prospective insureds, thereby expanding the insurance company's universe of potential customers.

Moreover, the automatic assembling of the reports) by the centralized report processor 114 may allow inspection reports to become available more quickly after the inspection than is the case with conventional loss control inspection practices. This may result in better customer service by the insurance company.

Referring again to FIG. 6B, block 652 represents the centralized report processor 114 making the reports generated at 646-650 available to the intended recipients. The centralized report processor 114 may accomplish this, for example, by emailing the reports to the recipients and/or sending to them hyperlinks that point to the reports (assuming that the reports are stored in partitions within the centralized report processor 114 that are accessible to the report recipients). In addition or alternatively, the centralized report processor 114 may print out the reports and cause them to be sent by postal mail or the like to the intended recipients.

In some embodiments, in a step not explicitly shown in FIGS. 6A/6B, the loss control inspector and/or a supervisor or another insurance company employee may review (and possibly edit) the reports before they are made available to the recipients.

Some or all of the data gathered at the inspection site 106 via the wearable data-gathering device 102 may also be stored in the centralized report processor 114 apart from the reports generated from the data. Thus, the centralized report processor 114 may store data resources that represent the raw/additional/secondary data gathered via the wearable data-gathering device 102. As represented by block 654 in FIG. 6B, the centralized report processor 114 may make this data resource available to the loss control inspector, supervisory insurance company personnel, underwriters, and/or other individuals who may benefit from access to the data resource.

In some embodiments, the data resource made available at 654 may be at least partially constituted by visual and/or textual data that may be suitable to provide evidence of a baseline condition of the inspected premises that may be referenced for claim evaluation purposes in the event of a subsequent loss.

As indicated by block 656 in FIG. 6B, an insurance underwriter (not shown) may access the underwriter report assembled at 646 (e.g., the access may be via a user device 118, FIG. 1). Further, the underwriter may use the underwriter report in connection with an underwriting process for an insurance policy to cover the inspection site 106. For example, the underwriter may determine or adjust pricing for the insurance policy based at least in part on information contained in the underwriter report.

In embodiments described herein, the loss control inspector's mobile device (e.g., a smartphone) serves as a relay point in data flowing between the wearable data-gathering device 102 and the centralized report processor 114. However, in other embodiments, the wearable data-gathering device 102 may have capabilities for mobile data communications similar to those of a smartphone or other mobile device. Accordingly, in some embodiments, the mobile device 110 may be omitted and data may be communicated from the wearable data-gathering device 102 to the centralized report processor 114 (and/or in the other direction as well), without being relayed via a mobile device apart from the wearable data-gathering device 102.

Embodiments of the invention have been described above in the context of facilitating loss control inspections. The teachings of this disclosure are also applicable to other types of activities, including for example activities by insurance claim adjusters. So, for example, a suitable app or apps may be developed according to guidance provided herein to aid a claim adjuster in gathering data (and potentially initiating an automatically-generated adjuster's report) about an insurance claim, via the adjuster's use of a wearable data-gathering device similar to the device 102 described herein.

The process descriptions and flow charts contained herein should not be considered to imply a fixed order for performing process steps. Rather, process steps may be performed in any order that is practicable.

As used herein and in the appended claims, the term “computer” refers to a single computer or to two or more computers in communication with each other and/or operated by a single entity or by two or more entities that are partly or entirely under common ownership and/or control.

As used herein and in the appended claims, the term “processor” refers to one processor or two or more processors that are in communication with each other.

As used herein and in the appended claims, the term “memory” refers to one, two or more memory and/or data storage devices.

As used herein and in the appended claims, an “entity” refers to a single company or two or more companies that are partly or entirely under common ownership and/or control.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A multi-media data gathering and formatting system for generating insurance company loss control inspection reports, the system comprising:
a first device for capturing visual information at an inspection site;
a second device for relaying the captured visual information to a third device;
the second device for transmitting, to the first device, report section prompts to be audibly and/or visibly reproduced to a user by the first device;
the first device for receiving spoken word input from the user, the spoken word input converted by speech-to-text processing into report segment text;
the second device for relaying the report segment text to the centralized report processor;
the third device automatically editing and assembling the report segment text into a first report in a first format, the report in a plurality of first sections, at least some of the first sections including at least one respective portion of the captured visual information;
the third device making the first report available to an insurance underwriter;
the third device automatically editing and assembling the report segment text into a second report in a second format different from the first format, the second report in a plurality of second sections;
the third device making the second report available to an insurance customer that is a proprietor of the inspection site.

2. The system of claim 1, wherein the first device is a wearable data-gathering device worn by the user.

3. The system of claim 2, wherein the second device is a mobile telecommunications device carried by the user and in communication with the wearable data-gathering device.

4. The system of claim 3, wherein the third device is a centralized report processor in communication with the mobile telecommunications device.

5. The system of claim 4, wherein:
the wearable data-gathering device includes a processor supported on a support frame, the support frame including:
a first temple piece for resting on the user's right ear;
a second temple piece for resting on the user's left ear; and
a central portion that bridges between the first temple piece and the second temple piece, the central portion shaped for being supported on the user's nose.

6. The system of claim 5, wherein the wearable data-gathering device further includes a camera and a microphone supported on the support frame.

7. A method of generating insurance company loss control inspection reports, the method comprising:
presenting report section prompts to a wearer of a wearable data-gathering device while the wearer is at a loss control inspection site;
receiving data inputs via the wearable data-gathering device and in response to the report section prompts;
storing the data inputs in a centralized insurance company data storage facility in association with respective report sections that correspond to the report section prompts;
automatically editing and assembling the stored data inputs into a first report in a first report format, the first report format including at least some of said report sections;
making the first report available to an insurance underwriter;
automatically editing and assembling the stored data inputs into a second report in a second report format different from the first report format; and
making the second report available to an insurance customer that is a proprietor of the inspection site.

8. The method of claim 7, wherein the editing and assembling steps are performed by the centralized insurance company data storage facility.

9. The method of claim 7, wherein the storing step includes relaying the data inputs from the wearable data-gathering device to the centralized insurance company data storage facility via a mobile telecommunications device carried by the wearer of the wearable data-gathering device.

10. The method of claim 9, wherein the mobile telecommunications device is a smartphone.

11. The method of claim 7, wherein the presenting step includes retrieving the report section prompts from the centralized insurance company data storage facility.

12. The method of claim 7, further comprising:
prompting the wearer of the wearable data-gathering device to ask questions of an interlocutor at the loss control inspection site.

13. The method of claim 12, wherein the step of receiving data inputs includes receiving and storing in the wearable data-gathering device audible responses provided by the interlocutor in response to the questions.

14. The method of claim 13, further comprising:
using speech-to-text conversion processing to convert the received audible responses to text.

15. The method of claim 7, wherein the step of receiving data inputs includes receiving and storing audible utterances from the wearer of the wearable data-gathering device.

16. The method of claim 15, further comprising:
using speech-to-text conversion processing to convert the received audible utterances to text.

17. The method of claim 7, wherein the step of receiving data inputs includes receiving and/or storing still and/or moving images generated by a camera that is part of the wearable data-gathering device.

18. The method of claim 17, wherein at least one of the first and second reports includes at least some of the stored still and/or moving images.

19. The method of claim 7, further comprising:
exchanging communications via the wearable data-gathering device between the wearer and an individual who is located remotely from the inspection site, the remotely-located individual having expert knowledge relevant to an inspection process performed by the wearer.

20. The method of claim 7, further comprising:
pricing an insurance policy for the inspection site by the insurance underwriter based at least in part on the first report.

21. A system for generating insurance company loss control inspection reports, the apparatus comprising:
a processor; and
a memory in communication with the processor and storing program instructions, the processor operative with the program instructions to perform functions as follows:
receiving data input from a wearable data-gathering device, the wearable data-gathering device present at an inspection site;
storing the received data inputs;
automatically editing and assembling the stored data inputs into a first report in a first report format;
making the first report available to an insurance underwriter;
automatically editing and assembling the stored data inputs into a second report in a second report format different from the first report format; and
making the second report available to an insurance customer that is a proprietor of the inspection site.

22. The system of claim 21, wherein the data inputs are received directly from the wearable data-gathering device.

23. The system of claim 21, wherein the data inputs are received from the wearable data-gathering device via a mobile telecommunications device in local communication with the wearable data-gathering device.

24. The system of claim 21, wherein:
the wearable data-gathering device includes a processor supported on a support frame, the support frame including:
a first temple piece for resting on a user's right ear;
a second temple piece for resting on the user's left ear; and
a central portion that bridges between the first temple piece and the second temple piece, the central portion shaped for being supported on the user's nose.
